(19) United States
(12) Patent Application Publication
(10) Pub. No.: US 2002/0019812 A1
(43) Pub. Date: Feb. 14, 2002

(54) System and service for receiving, customizing, and re-broadcasting high-speed financial data to users operating wireless network-capable devices

(76) Inventors: Karen Eleanor Board, Vancouver (CA); Flora Golshan, Scarsdale, NY (US); Cornel R. Fota, North Vancouver (CA)

Correspondence Address: CENTRAL COAST PATENT AGENCY, PO BOX 187, AROMAS, CA, 95004, US

(21) Appl. No.: 09/881,331

(22) Filed: Jun. 13, 2001

Related U.S. Application Data
(60) Provisional application No. 60/212,448, filed on Jun. 16, 2000.

(51) Int. Cl. G06F 17/60

(52) U.S. Cl. 705/51

(57) ABSTRACT

A network-based system for intercepting real-time data feeds from external data sources, stripping the intercepted feeds of user-ordered data and redirecting the stripped data to the requesting users over cooperating interfacing networks is provided. The system comprises, one or more server nodes connected to the network, at least one of which is input ported for receiving data feeds from the external data sources and output ported for rendering data stripped from the feeds to requesting users, one or more instances of software distributed to the one or more server nodes, the software for parsing data from the feeds received from the external data sources, converting the data to a common markup language for internal processing, and for converting user-ordered data results expressed in the common markup language to appropriate interface formats for the requesting users, the software also for accepting data about users and configuration data from users interfacing with the software by way of an Internet-capable appliance and supported platform and a mass data storage repository accessible to the one or more server nodes, the data repository for storing data stripped from feeds provided by the external data sources and for storing user profile and account data. Users subscribing to a service enabled by the system may order and receive data stripped from the data feeds provided by the external data sources in a usable presentation format personalized to each user and rendered to each user through a particular cooperating interface network to the particular wireless communication device operated by individual ones of the users, the device configured for receiving the data.

### CROSS-REFERENCE TO RELATED DOCUMENTS

The present non-provisional application claims priority to and has been converted from provisional patent application No. 60/212,448 entitled “Global Market Professional” filed on Jun. 16, 2000. The entire disclosure of application No. 60/212,448 is included herein in its entirety by reference.

### FIELD OF THE INVENTION

The present invention is in the field of financial data services and pertains particularly to systems that distribute broadcast data feeds to targeted end users, and also pertains particularly to systems providing delivery by wireless devices, but also over other output means.

### BACKGROUND OF THE INVENTION

Financial institutions have long provided mechanisms through which public financial data such as stock prices, interest rates, commodity rates, money market rates, and the like are delivered to end users who use the information to make purchasing and other decisions related to the received information. Real or near real-time financial information has been made available to users through the likes of television and radio broadcasts as well as specialized wire services that broadcast worldwide. Likewise, newspapers and other specialized publications carry financial information to users albeit typically not in real time.

More recently, with the advent of the Internet network, financial information feeds have been available through network-connected nodes usually referred to as data servers. Users have access to these information sources through connecting to the network and then connecting to a source server using a standard Internet-capable appliance such as a desktop computer.

With such capability as described above, users who trade stocks, currencies, and other financial instruments may view near-real-time data feeds delivered to electronic interfaces, known as Web pages, maintained at the source servers. Online brokerages and other financial institutions having an online (network connected) presence are numerous and offer a variety of accessible, interactive services related to the delivery of some type of financial data or news.

A problem with such prior art interfacing technology is that it is restrictive in the sense that users must use a multipurpose computing device in order to access and utilize the information, which may be graphically intensive and require significant bandwidth. Moreover, users engaged in much trading activity in the free market require significant amounts of time for monitoring market conditions, researching articles about stock offering companies, and so on. This time is, of course, spent in front of an interfacing computer or other relatively fixed appliance taking the user away from other duties, appointments, engagements or the like, which the user may have planned at any given time.

Another issue that has been largely overlooked by companies providing financial information services is the aspect that certain users only wish to access certain types of financial data. For example, a user investing in a specific number of stocks may only wish to view information about those particular stocks and companies providing them, without having to pore over data that he or she is simply not interested in. Likewise, a user interested in only specific commodities does not want to waste time wading through un-related data in order to receive the specific data portions related to the commodities of interest.

Prior art data services supply data feeds that are generic to everyone and specific to no one. That is to say that a user may have to view an online stock ticker, for example, for some time before his or her particular symbols of interest are displayed. Some on-line interfaces allow users to select specific stock symbols for on-demand data updates; however, the selection choices are invariably limited as well as the depth of information available.

What is clearly needed is a system and service for receiving, customizing, and then re-broadcasting important financial information to users operating a variety of portable, network-capable devices. Such a system and service would provide the convenience of mobility to a user while transacting with a particular financial institution or financial market data or news provider, and would provide users with the most recent, updated information required for decision-making.

### SUMMARY OF THE INVENTION

In a preferred embodiment of the present invention, a network-based system for intercepting real-time data feeds from external data sources, stripping the intercepted feeds of user-ordered data and redirecting the stripped data to the requesting users over cooperating interfacing networks is provided. The system comprises, one or more server nodes connected to the network, at least one of which is input ported for receiving data feeds from the external data sources and output ported for rendering data stripped from the feeds to requesting users, one or more instances of software distributed to the one or more server nodes, the software for parsing data from the feeds received from the external data sources, converting the data to a common markup language for internal processing, and for converting user-ordered data results expressed in the common markup language to appropriate interface formats for the requesting users, the software also for accepting data about users and configuring data from users interfacing with the software by way of an Internet-capable appliance and supported platform or two-way wireless device capable of submitting said information, and a mass data storage repository accessible to the one or more server nodes, the data repository for storing data stripped from feeds provided by the external data sources and for storing user profile and account data.

Users subscribing to a service enabled by the system may order and receive data stripped from the data feeds provided by the external data sources in a usable presentation format personalized to each user and rendered to each user through a particular cooperating interface network to the particular wireless communication device operated by the individual users, where the devices are configured for receiving the data.

In a preferred embodiment the system is implemented on the Internet network. The cooperating interfacing networks in one embodiment include one or a combination of a paging network, a digital wireless network, and a wireless Internet service network. In all aspects, the data feeds contain publicly oriented financial activity and news information. In a preferred application, the common markup language is eXtensible Markup Language.

In a preferred embodiment, the wireless communication devices configured for receiving the data rendered by the system are one of a one-way pager, a two-way pager, a hand-held computing device , often referred to as a Personal Digital Assistant (PDA), or a Web-enabled telephone, such as by Wireless Access Protocol (WAP) technology. The data received from external data sources is parsed and converted into eXtensible Markup Language before being converted to the appropriate data format and being rendered. In one aspect, data rendered to users is of the form of alerts triggered through detection of specific and variable conditions associated with the data, the conditions configured into orders received from users (devices capable of receiving PUSH messages). Also in one aspect, data rendered to users further includes most recent real-time values associated with the desired data.

In a network-based system for intercepting real-time data feeds from external data sources, stripping the intercepted feeds of user ordered data and redirecting the stripped data to the requesting users over cooperating interfacing networks, the system having one or more server nodes connected to the network, at least one of which is input ported for receiving data feeds from external data sources and output ported for rendering data stripped from the feeds to requesting users, a software application for managing the functions of the system is provided. The software comprises, a user-interface component for interfacing with users for the purpose of accepting data about users and for accepting orders from users, a source-interface component for receiving data feeds from external data sources, parsing the data feeds for data pertinent to user orders, and for directing the parsed data into a data repository, a data-conversion component for equating data expressed in formats used by external sources to a common markup language for internal processing and for equating data results expressed in the common markup language to appropriate data formats used by receiving devices (devices capable of receiving PULL messages) operated by requesting users, a data-transport component for transporting processed data to requesting users through the output of the system, and a database management component for managing database operations including associating appropriate data parsed through order to appropriate requesting users.

The software is characterized in that users interacting with the interface component of the software application may subscribe to the service enabled by the software, create a personal portfolio, and configure data alert and data presentation orders through the interface component or wireless device for subsequent execution, processing, and rendering performed by the remaining components of the software application.

In a preferred embodiment, the user-interface component is accessible through the Internet using an Internet-capable computing device, or wireless data network connected to the Internet. In one embodiment, the Internet-capable computing device is a personal computer. In another embodiment, the Internet-capable computing device is a hand-held computer or paging device. In one embodiment, the software application is distributed to a single server node in the case of one server node. In another embodiment, the software application is distributed to more than one server node in the case of more server nodes.

In a preferred aspect of the software application, data about users includes account data, contact data, device data, and portfolio data. In this aspect, orders from users include conditional alert orders, time-sensitive alert orders, and event-driven alert orders. In one embodiment, orders from users received through the user-interface component result in periodic data pushes to the device of the requesting user. In another embodiment, orders are received through bi-directional interface with the data-transport component, the orders comprising on-demand orders.

In another aspect of the present invention, a method for receiving real-time data feeds from data sources accessible through data connection, parsing, and stripping the feeds for data portions for redirection to users connected by data link is provided. (The following describes PUSH) The method comprises the steps of, (a) receiving an order for data from a user, the user sending the order through the data link, (b) parsing a data feed identified in the received order, the data feed continually tapped by the service and the parsing performed to identify data in the feed that is identified by the order, (c) stripping the portions of data from the data feed according to instructions contained in the order, (d) associating the stripped portions of a data to the author of the order for the data and, (e) transporting the data to the user back over the data link.

In a preferred application of the method, the data connection to the external sources comprises the satellite or direct line network and the data link comprises a wireless data link facilitated by a wireless service carrier. In one aspect of the method in step (a), the data link is one of a digital wireless data link, a pager network data link, or a wireless Internet (WAP) data link. (The following describes PULL) Also in one aspect, in step (a), the order is an on-demand order initiated through one of a two-way pager, a hand-held computing device, or a Web-enabled (WAP) telephone. In another aspect of the method in step (b), the data feed contains market activity information and the order requests the most current activity values associated with specific instruments reported by the feed. Also in another aspect in step (b), the data feed contains market news information and the order requests the most current news summaries as reported by the feed. In another aspect of the method in step (c), instructions contained in the order pertain to one or more instruments generic to the data feed. In still another aspect of the method, steps (a)-(e) are repeated a plurality of times during one session on behalf of one user engaging in the session.

In still another aspect of the present invention, a method for generating and transmitting user alerts associated with current states and conditions of data contained in real-time data feeds intercepted on behalf of users by a network-based data interception and redirection service is provided. The method comprises the steps of, (a) receiving at the service a configuration order sent by a user the order identifying specific alert criteria and received by the service over a data link connecting the service to the user, (b) monitoring one or more real-time data feeds identified in the configuration order received at step (a), the monitoring performed to identify the data in the feed which is identified in the configuration order and also the current state and condition of the identified data, (c) comparing the alert criteria specified in the configuration order to the identified state and condition of the associated data and (d) upon determining that the current state and condition of the associated data meets the alert criteria specified in the configuration order, generating and transmitting an associated alert or alerts to the author of the configuration order.

In a preferred embodiment, the network-based data interception and redirection service is implemented on the Internet network. Also in a preferred embodiment, the data interception and redirection service utilizes interfacing wireless networks to transmit alerts to wireless devices using a push technology. In one aspect of the method in step (a), the data link connecting the service to the user is an Internet link and the device used to initiate the configuration order is a personal computer. In another aspect, in step (b), the real-time data feeds report traded financial instruments and current market states and conditions of those instruments. Also, in step (b), monitoring of the feeds occurs continuously or periodically as specified by the configuration order. In still another aspect of the method in step (c), comparison of alert criteria to state and condition of associated data is performed at each periodic interval of monitoring. In step (d) of the above-described method, transmission of a generated alert or alerts is conducted through an interfacing wireless network to a configured wireless device adapted to receive the alert or alerts. In one embodiment, the wireless device is a one-way paging device and interfacing network is a pager network. In another embodiment, the wireless device is a two-way paging device. In yet another embodiment, the wireless device is a hand-held computing device and interfacing network is a wireless data network.

Now for the first time, a system and service is provided that enables users operating mobile communications devices to track financial instruments and receive current states and conditions as well as alerts and news related to such instruments in an automated fashion. Such a system and service provides the convenience of mobility to a user while transacting with a particular financial institution or financial market data or news feed, and provides users with the most recent, updated information required for decision-making.

### BRIEF DESCRIPTION OF THE DRAWING FIGURES

FIG. 1 is an overview diagram of the present invention as practiced in preferred embodiments.

FIG. 2a is a diagram illustrating a process of account maintenance represented in FIG. 1.

FIG. 2b is a diagram representing a PUSH information process in an embodiment of the present invention.

FIG. 2c is a diagram illustrating a PULL process for information delivery according to an embodiment of the present invention

FIGS. 3a-3d illustrate an electronic user interface for editing portfolio settings according to an embodiment of the present invention.

FIGS. 4a-4e show instrument types associated with particular configuration templates associated with data presentation devices, and screens for adding and editing template settings in an embodiment of the invention.

FIGS. 5a and b illustrate an electronic user interface for editing portfolio settings according to an embodiment of the present invention.

FIGS. 6a and b also illustrate an electronic user interface for editing portfolio settings according to an embodiment of the present invention.

FIGS. 7a and b show a table representing various filter types and identifiers associated with a particular type of financial instrument and configuration template associated with data presentation to devices capable of receiving pushed information in an embodiment of the invention.

FIG. 8 is a table representing various alert types associated with descriptive identifiers.

FIGS. 9a-c illustrate an electronic user interface for editing news portfolio settings according to an embodiment of the invention.

FIGS. 10a-d illustrate a series of electronic user interfaces as appearing on a two-way paging device, followed by a series of additional electronic user interfaces accessible through further action with options presented in the interfaces, in an embodiment of the invention.

FIG. 11 illustrates an exemplary user interface configured for a Web-enabled wireless telephone, followed by a series of additional electronic user interfaces accessible through further action with options presented in the interfaces.

FIGS. 12a-c illustrate a series of electronic user interfaces as appearing on a PDA device, followed by a series of additional electronic user interfaces accessible through further action with options presented in the interfaces.

FIG. 13 illustrate a series of electronic user interfaces as appearing on a Motorola PageWriter two-way paging device, followed by a series of additional electronic user interfaces accessible through further action with options presented in the interfaces.

### DESCRIPTION OF THE PREFERRED EMBODIMENTS

According to a preferred embodiment of present invention a hardware/software system for intercepting data and redirecting the data to a variety of wireless and mobile users according to personal profile is provided. The methods and apparatus of the present invention are described in enabling detail below.

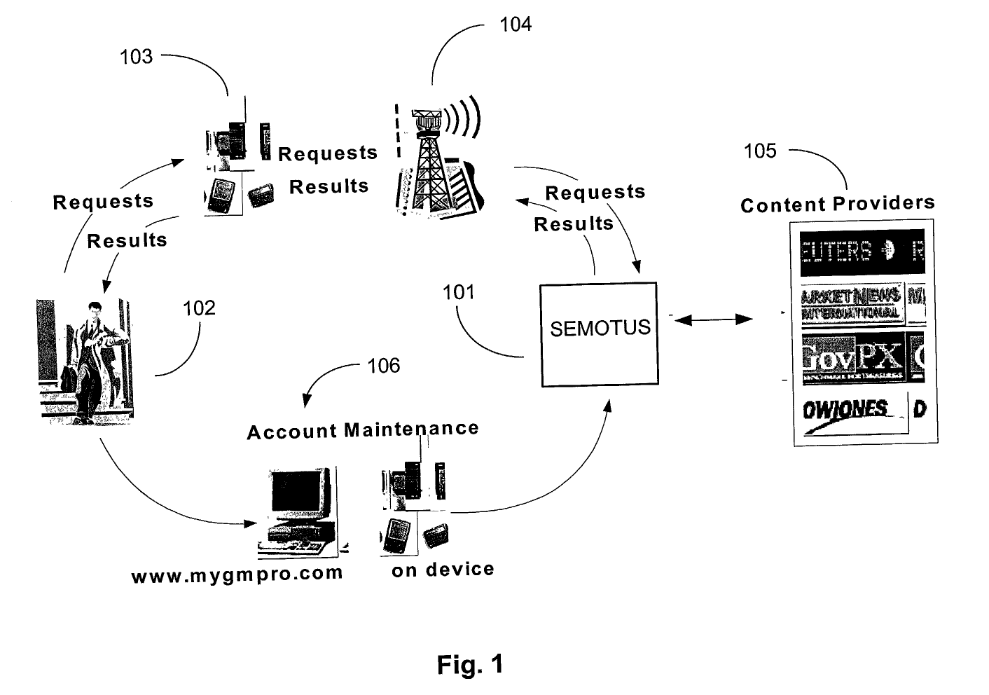

FIG. 1 is an architectural overview of the present invention. In this overview system 101 represents a central infrastructure configured and enabled to maintain user (subscriber) accounts, and to accept requests for information from users and to deliver information satisfying the requests. Icon 102 represents an individual user of many, grouping 103 represents examples of devices that a user might use to access information in the system, and antenna 104 represents a wireless access infrastructure. In preferred embodiments of the system, users may utilize devices capable of two-way communication, in which case the users may request (pull) information as wanted or needed; or may utilize devices which are also (or only) capable of receiving information, in which case information may be pushed according to a pre-programmed schedule or driven by market events.

The central infrastructure 101 is connected to a plurality of data feeds (content providers) 105, shown in FIG. 1 as Reuters™, MarketNews International™, GovPX™, and Dow Jones™. These are the providers of the financial information provided to users, either by push or pull.

Users are typically subscribers to the system, and account maintenance is done by a different route than that for providing information to light devices or via the device itself in the case of two-way devices, as shown through wireless service 104. In preferred embodiments account creation and maintenance is done via a Web connection, such as through an Internet Service Provider, to a Web site connected to or a part of infrastructure 101. One with skill in the art will recognize that this particular route is one of convenience, and that account creation and maintenance may well be done in a variety of other ways, such as by voice interaction with agents of the service, for example.

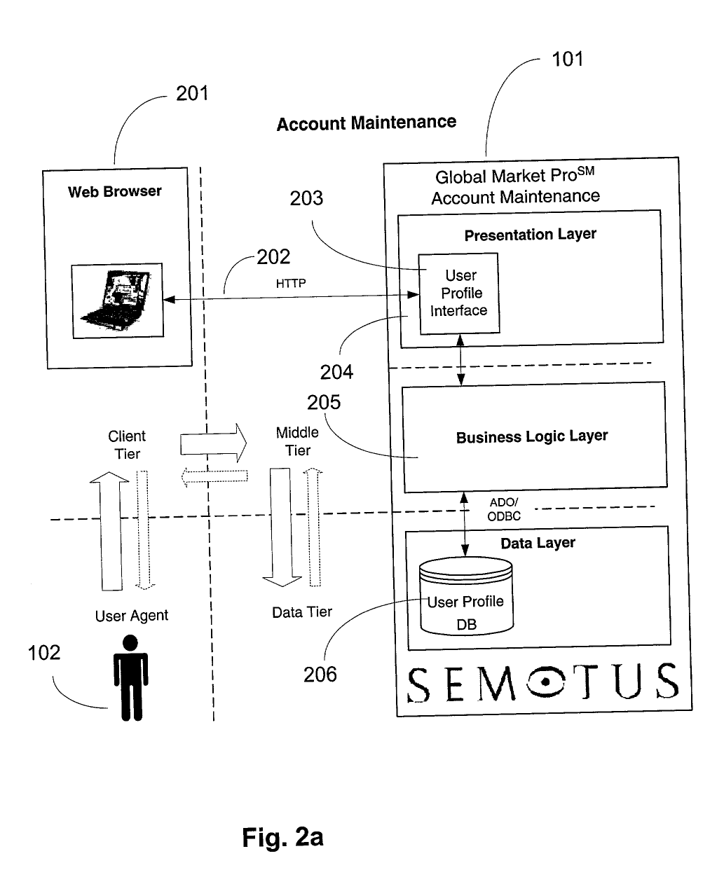

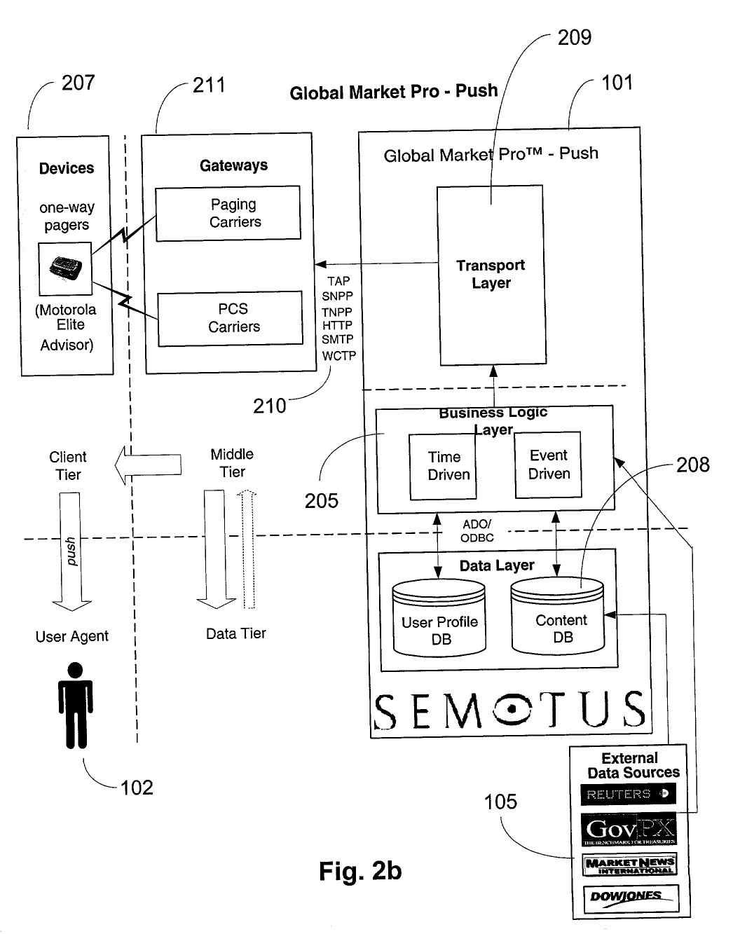

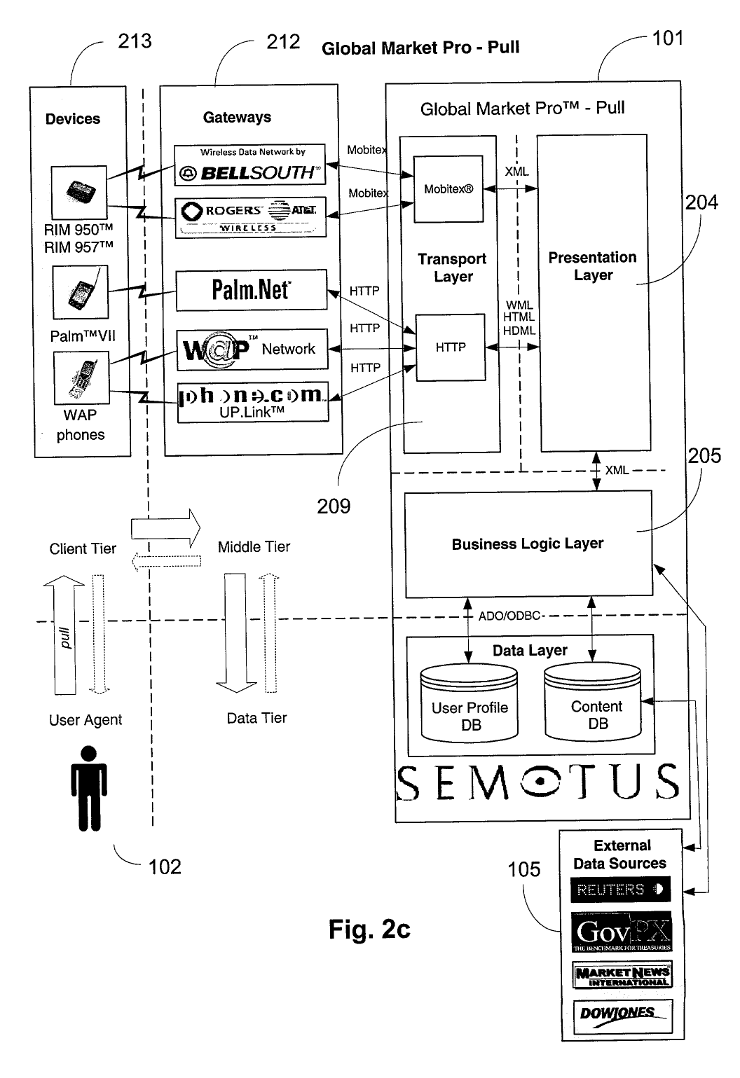

FIG. 2a is a diagram illustrating the process of account maintenance represented as element 106 in FIG. 1. As previously described, account creation and maintenance is typically implemented via the Internet to a Web server associated with infrastructure 101 in FIG. 1. FIG. 2a illustrates user 102 interacting with infrastructure 101 via a Web browser 201 by an HTTP connection 202 to a User Profile Interface 203 in a software presentation layer 204 in infrastructure 101. The User Profile Interface operates through a Business Logic Layer 205 to establish and edit user profiles stored in a User Profile Database 206. A user may establish and amend many parameters in his/her profile, such as the type of device(s) used, the content providers to access, and much more, which is described in additional detail below.

FIG. 2b is a diagram illustrating a PUSH process for information delivery according to an embodiment of the present invention. In this example user 102 is accessing the service of the invention using a device 207 that is not capable of two-way communication (however, some two-way devices such as the RIM 957 are capable of receiving PUSH data). The device in this example is a Motorola Elite Advisor™. There are a number of such one-way devices, and the one shown is merely one example of many.

System 101 in this example has a content database 208 in which information is stored, configured for individual users. Information from sources 105 (content providers) is mined and provided (by push) on either a time-driven or an event-driven basis, via transport layer 209 and any one of a number of possible data protocols 210, via a gateway 211 to device 207. Gateways shown are paging carriers and PCS carriers.

An example of time-driven PUSH is in the case of a user who has a profile indicating a one-way device, and who has configured his profile for delivery of certain stock information every five minutes. An example of event-driven PUSH is the possible case of the same user who has configured for stock prices for a particular stock, but has indicated in his profile that he only wants the quote when (and if) the price changes, either up or down, by more than six percent.

FIG. 2c illustrates a PULL information delivery process according to an embodiment of the present invention. In this example user 102 is using a two-way communication device 213, illustrated as one of a RIM™ device, a Palm VII™, or a WAP-enabled telephone. The skilled artisan will recognize that these three are merely examples of many such devices that may be at a user's disposal.

In the PULL example of FIG. 2c, devices 213 communicate with service 101 via gateways 212 which are in most cases specific to the kind of device and data protocol used. For example, the RIM™ devices access the service through a Mobitex™-enabled network such as BellSouth™ or AT&T™. The Palm™ device accesses through Palm.Net™, and the WAP-enabled telephone goes through a WAP network.

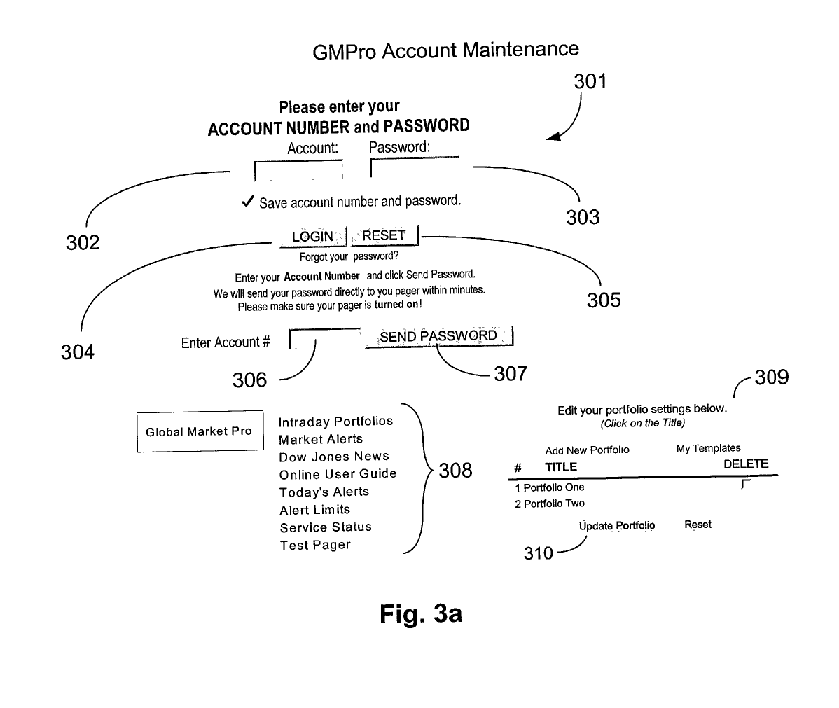

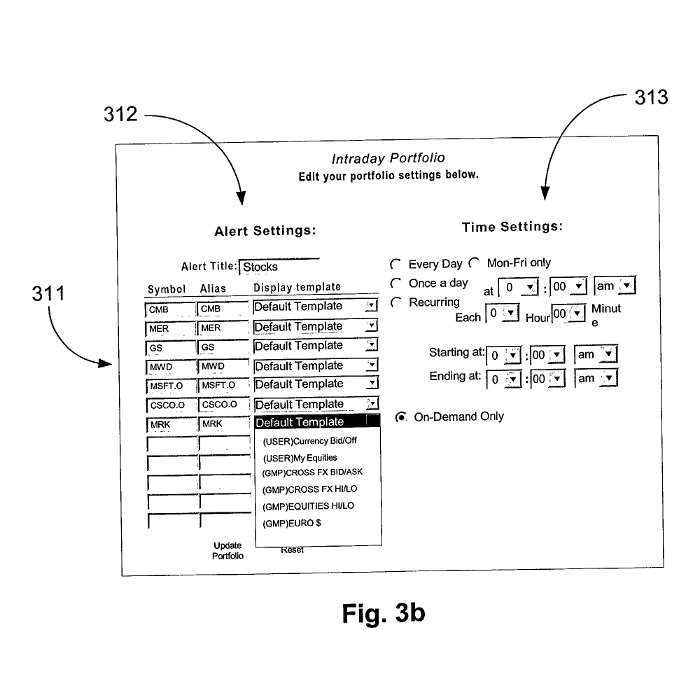

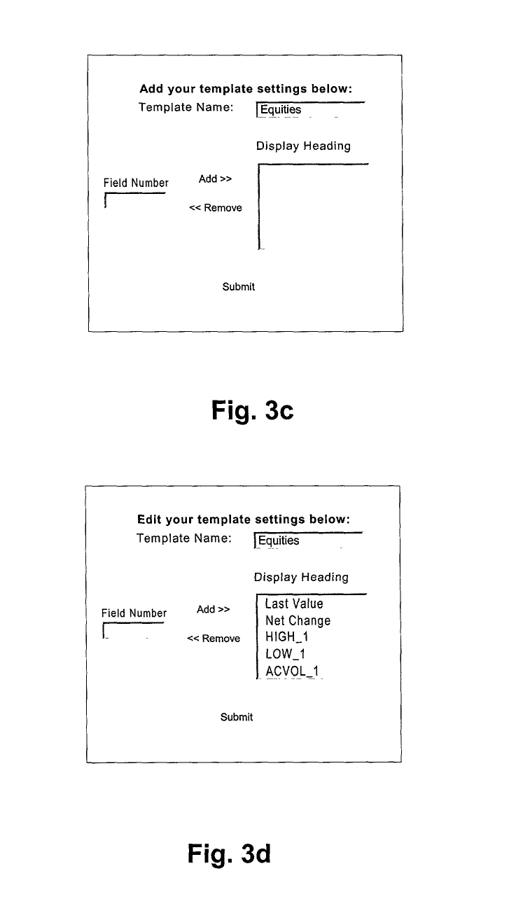

In system 101 transport layer 209 is enabled for communication with gateways 212 as required, such as by Mobitex or by HTTP through the well-known Internet. The balance of detail of system 101 is much the same as described previously for FIG. 2b. An essential difference is that user 102 is now enabled to request feeds and to interact with the system. Enabling examples of such interaction are provided in more detail below. FIG. 3a is an exemplary log-in interface 301 as presented to a user in account maintenance. The Account Maintenance server for system 101 in a preferred embodiment. Fields are provided for account (302) and password (303). Buttons 304 and 305 are for log-in and reset initiation. Field 306 and button 307 allow a user who has forgotten his password to retrieve same from the system via a paging device.

Once the user logs in, he or she is presented with a menu 308 of optional destinations, such as “Intraday Portfolios”, “Market Alerts”, and so on, which will take the user to windows that allow for editing of various parameters. Selecting “Intraday Portfolios” from menu 308 presents a choice 309, wherein the user may select an existing portfolio, may add a portfolio, or may jump to stored templates. The user highlights (for example) a listed portfolio, then initiates update (editing) via button 310, which results in display of the selected portfolio and its parameters as shown in FIG. 3b.

FIG. 3b is an exemplary Portfolio update window. Window 311 is divided into two regions 312, for Alert Settings, and 313 for Time Settings. The Alert Title in this case is “Stocks”, and the alerts are for selected stocks, editable by symbol and alias, and having drop-down menus for the user to specify a template for each stock listed. There is a default template, and a range of other selectable templates, which may be supplied by Global Market Pro, or designed by the user. An example drop-down menu for template selection is shown.

Region 313 for time settings allows the user to select a variety of time-delivery options for days, time-of-day, and so on; and an optional selection for “Demand Only”, in which case delivery will be made only upon demand by the user in a PULL transfer situation.

Selecting “My Templates” in FIG. 3a (button 309) jumps the user to his/her stored templates, where the user may add or edit templates, name the templates, and so on, which templates will then show on drop-down menu in region 312 of FIG. 3b, for “Display Template”. FIG. 3c shows an exemplary window for creating a new template, and FIG. 3d shows an exemplary window for editing an existing template.

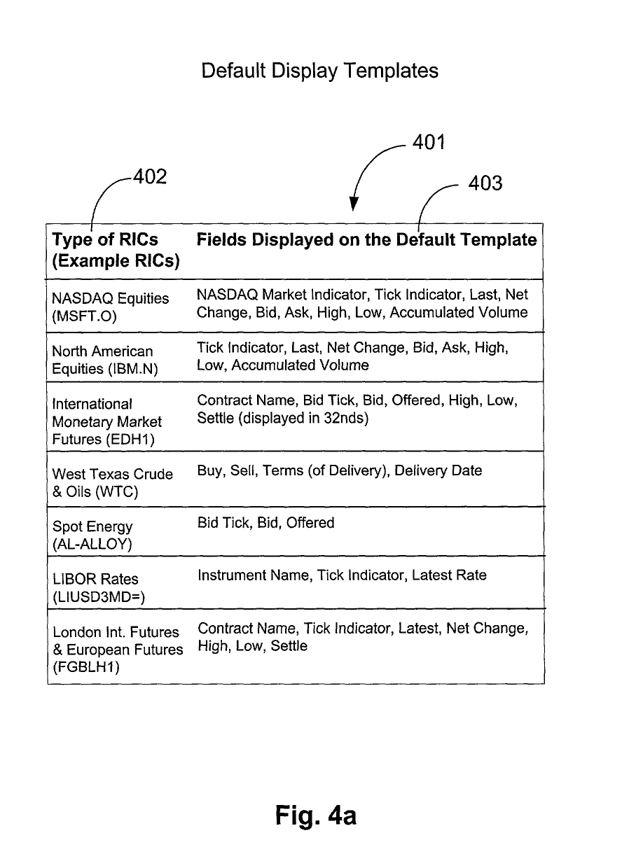

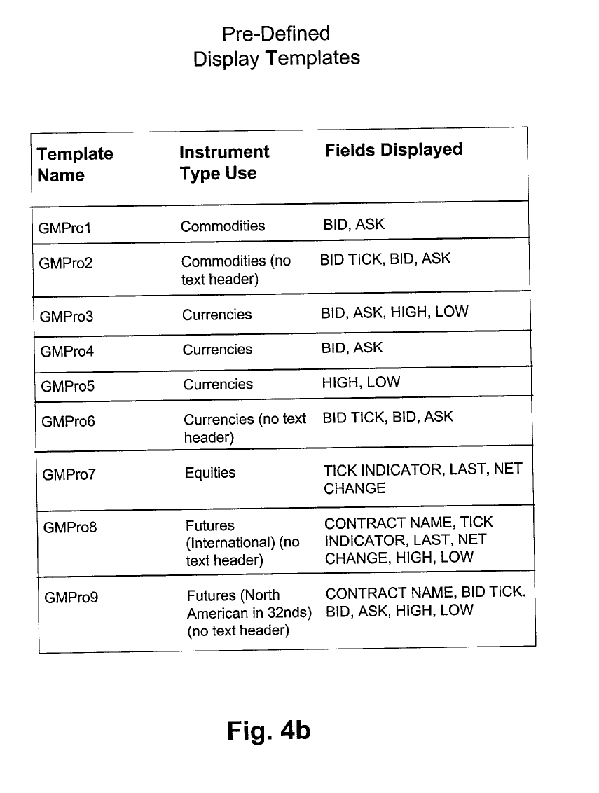

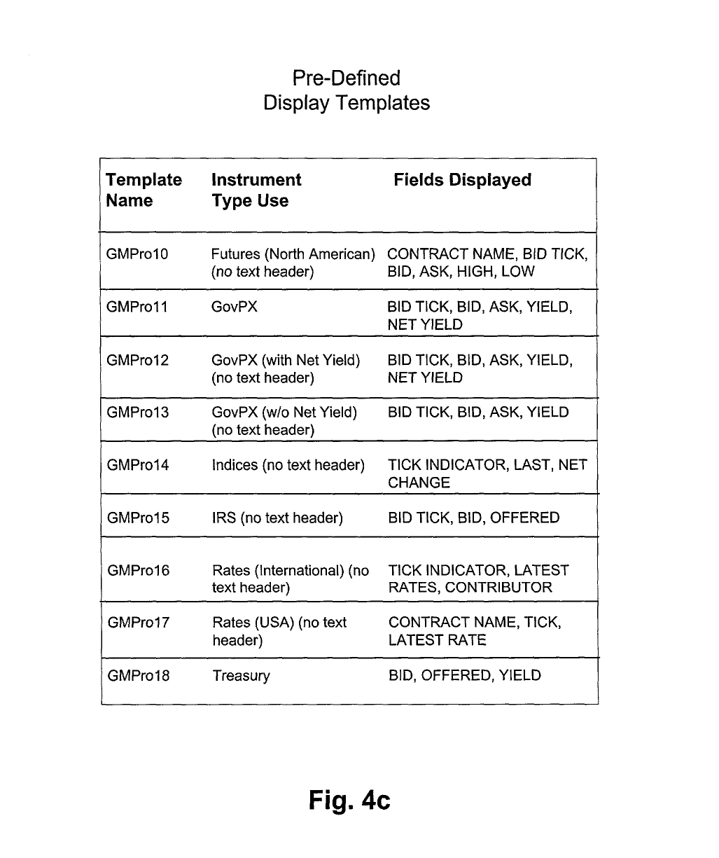

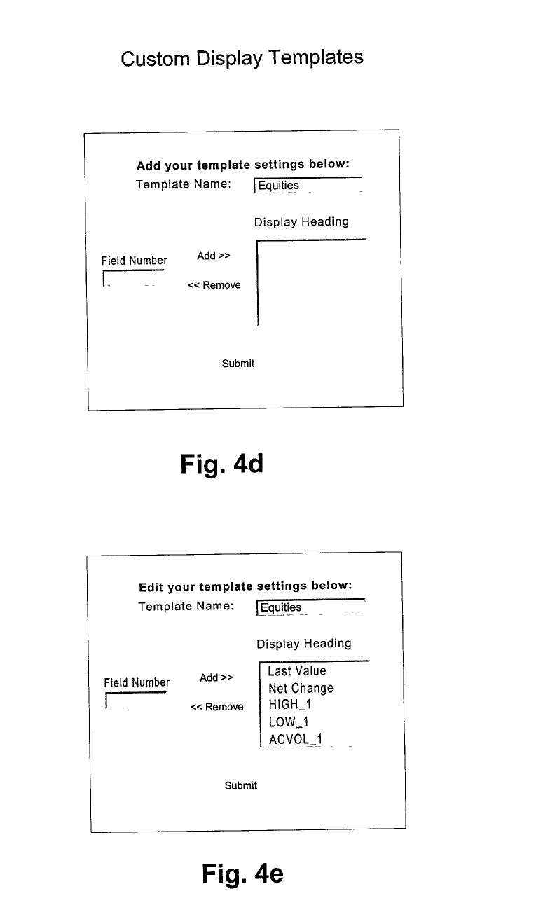

The service, which the inventors term Global Market Pro, provides a number of pre-defined default display templates, to ease the task for the user of creating templates for display of his/her desired information. FIG. 4a is a list 401 of a number of exemplary default display templates. The default templates are identified by the symbols of the financial instruments is this case Reuters Instrument Codes (RICs) examples of which are as shown in 402, including NASDAQ Equities, North American Equities, International Monetary Market Futures, West Texas Crude and Oils, Spot Energy, LIBOR Rates, and London International Futures and European Futures. For each default template identified by a RIC, a listing of fields displayed on the template is provided in 403.

FIG. 4b is a first listing of pre-defined display templates, created and provided by Global Market Pro. In this list nine pre-defined templates are shown for such as Commodities, Currencies, Equities and Futures. FIG. 4c shows a continued list of pre-defined templates for such as GovPX, Indices, Rates, and Treasury notes.

FIG. 4d illustrates a window wherein a user may add template settings for custom templates, and FIG. 4e illustrates a window wherein a user may edit settings for custom templates.

The skilled artisan will recognize that the ability to add custom templates and the range of pre-defined templates shown is exemplary only, and that the possible variety of such templates is very diverse.

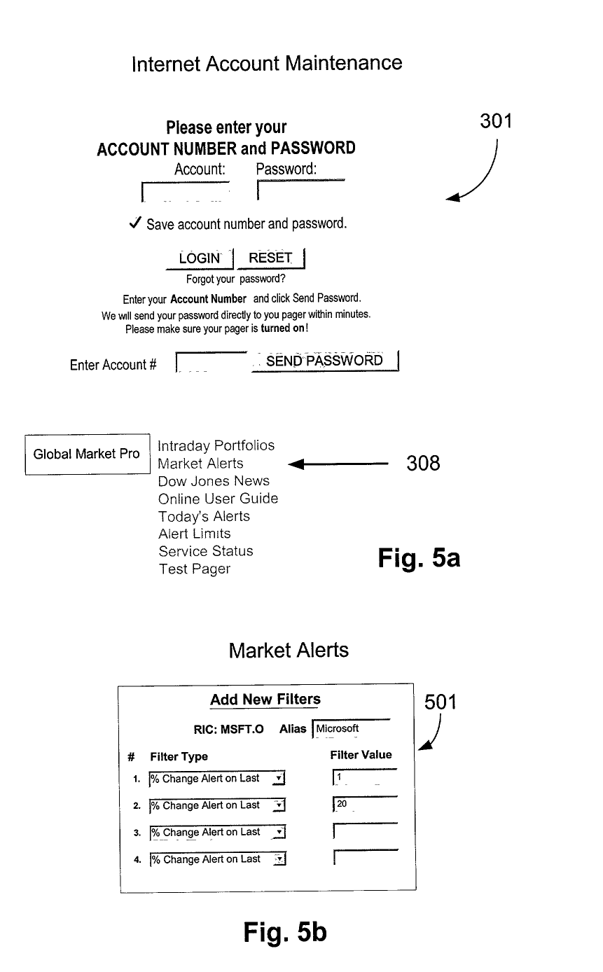

FIG. 5a illustrates login and initial selection for a user to enter account maintenance, in this case creating and editing Market Alerts (although users can move throughout the options available 308 without having to log out/log in). After log-in with familiar window 301 (see FIG. 3a and accompanying description), the user selects Market Alerts from options 308. The immediate result is a window 501 in FIG. 5b allowing the user to add new filters for alerts. In this window the RIC is displayed along with an editable alias, and filter types and filter values are selectable.

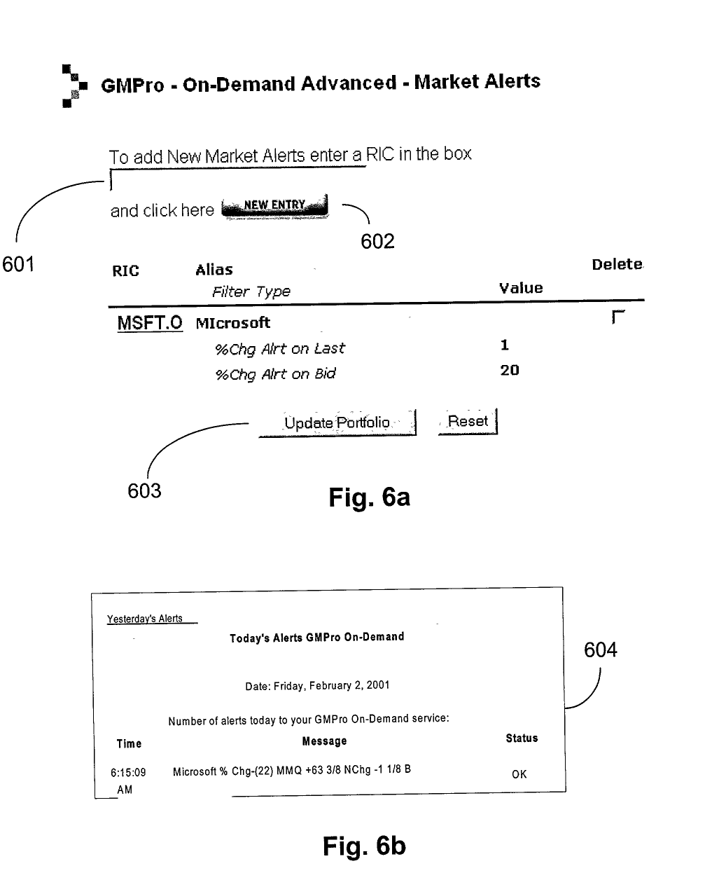

FIG. 6a illustrates a window provided for a user to edit previously created Market Alerts or to add new market alerts. In this example the user may enter a RIC in field 601 and initiate the process by button 602. Screen 309 in FIG. 5b will appear for items to be entered. The user may update the portfolio with the new alert by button 603.

FIG. 6b illustrates a report window 604 of the alerts that were sent according to the configuration for a portfolio. Dates, times, messages, and status are all displayed for the given day and the previous day's alerts.

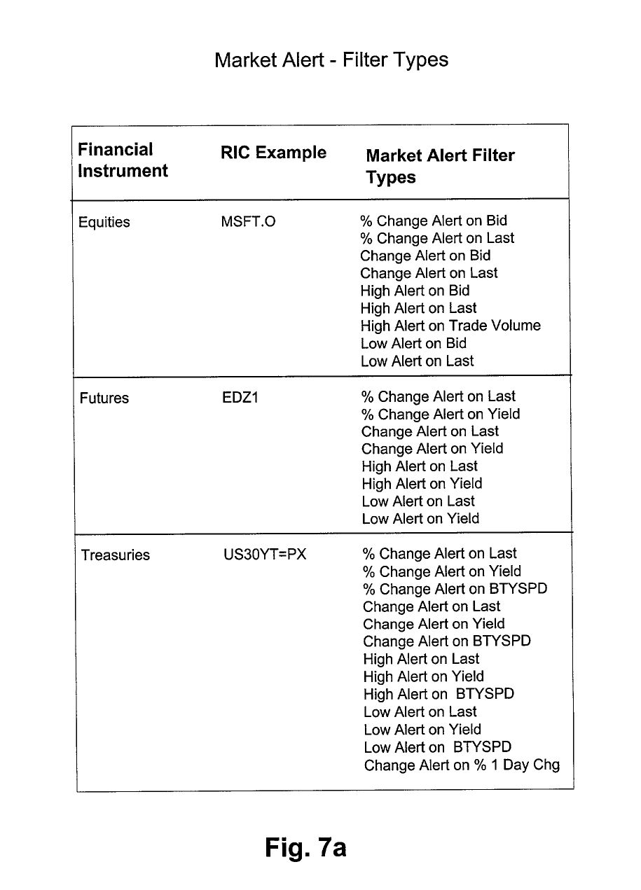

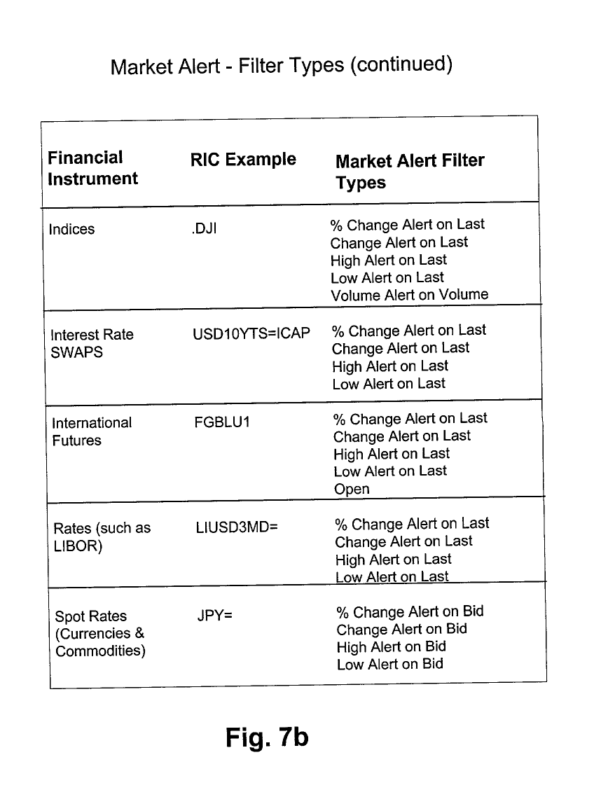

FIGS. 7a and 7b are tables listing Market Alert filter types that are provided by Global Market Pro for a user to configure his/her service profile. In this example, types of financial instruments are listed with an RIC example, and Market Alert filter types that are made available. These are various filter types available with a single financial instrument and user-ordered XML format strings describing particular alert types associated with the instrument. As was previously described throughout this specification, XML is a preferred internal descriptor language used by the software of the present invention for internal processing. In this case, data is parsed from the Reuters data feed according to template, the template listing available filter types and wherein a specific RIC associated with the template is masked with a particular to one or ones of the available alerts expressed in XML format for internal processing purposes.

The tables in FIGS. 7a and 7b simply lists examples of financial instruments, the available filter types that can be configured for the listed item, and the actual alerts that have been configured for the associated RIC by a user. During configuration using the Internet account-maintenance interface described elsewhere in the specification, a user may select alerts from a list of presented alerts such as from a drop-down menu, or in some embodiments enter desired alerts via natural language data entry. There are many possibilities. It is also noted herein, that a RIC may represent a group of instruments as well as a single instrument.

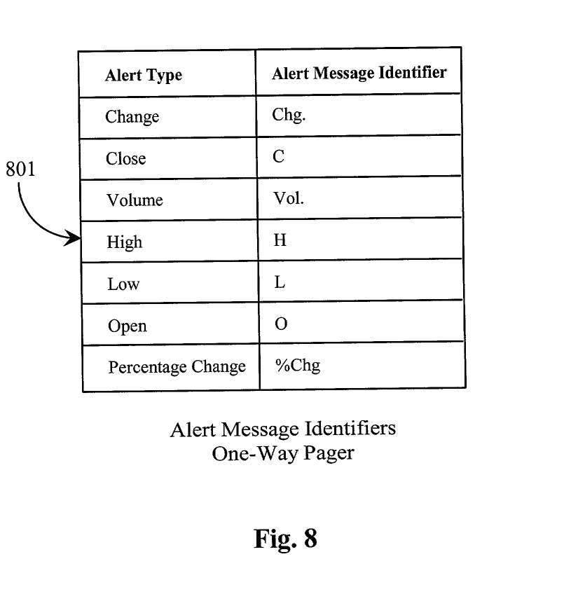

FIG. 8 shows a table 801 representing various alert types associated with descriptive identifiers for a one-way pager according to an embodiment of the present invention. Table 801 simply represents seven types of user alerts and associated symbols that identify the listed alerts. In this way, all identified states or conditions transmitted to users are equated with simplistic symbols enabling users to quickly understand the type of state or condition that has been transmitted. The table shows various alert types associated with descriptive identifiers for a device capable of receiving pushed messages according to an embodiment of the present invention. This table simply represents seven types of user alerts and associated symbols that identify the listed alerts. In this way, all identified states or conditions transmitted to users are equated with simplistic symbols enabling users to quickly understand the type of state or condition that has been transmitted.

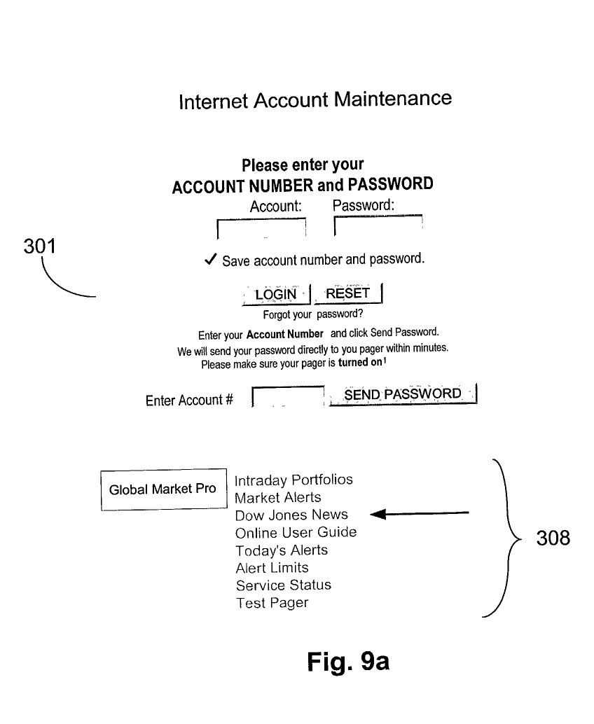

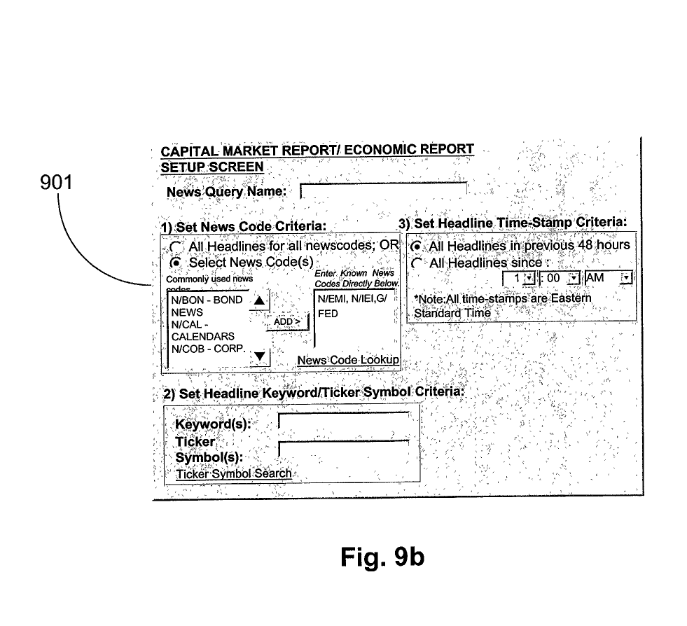

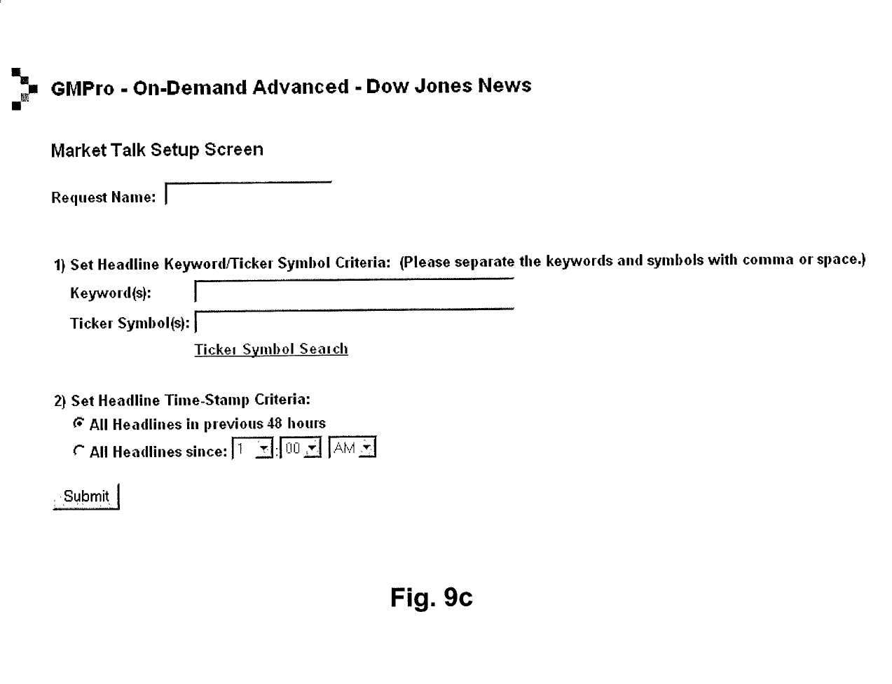

FIG. 9a, b, and c provide a further description of functionality provided in Global Market Pro for account set-up and maintenance. In FIG. 9a the user logs on via the familiar log-on screen 301, then selects Dow Jones News from options 308 (although users can move throughout the options 308 available without having to log out/log in) . . . The immediate result is a window 901 illustrated in FIG. 9b allowing the user to set up the form and content for a news report to be provided by Global Market Pro. The user may select All Headlines for all newscodes, or may select specific news codes. One may also manually enter news codes. Time-stamp criteria may also be set, and one may, in addition, set a headline search by keywords and /or ticker symbols. FIG. 9c is a Market Talk set-up screen for on-demand advanced for Dow Jones News. In this interface the user may enter a request name in field 902, and then enter keywords and ticker symbols, and also set Headline time-stamp criteria.

As previously described, Global Market Pro works with light devices of many sorts, as well as with more diversified and powerful systems, such as desk top machines. In some cases the light devices may be one-way devices, such that PULL transfer is not enabled, only PUSH may be used. In other cases the light devices are two-way communication devices, and pull technology may be used. In every case it is needed that the Global Market Pro service know the device used, so the correct communication protocol and configuration may be used. The knowledge of the device is a function of user profile set up.

It will be appreciated that nearly every different device will have a different and unique display and cursor control apparatus. For this reason Global Market Pro has created specific displays and orders of displays for many different devices. Detailing all that are available is beyond the scope of this document, but a good example is in order.

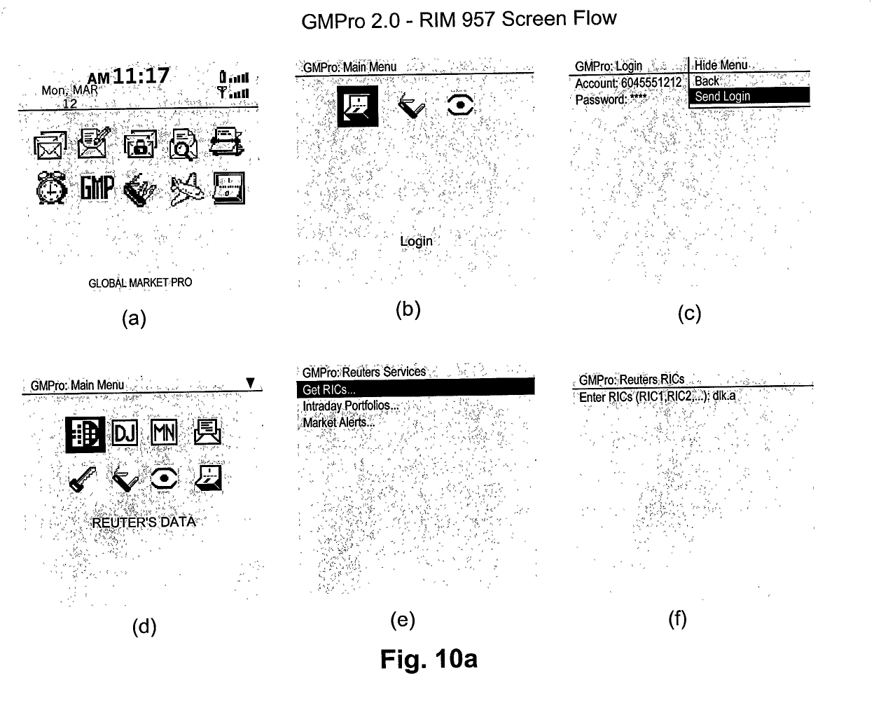

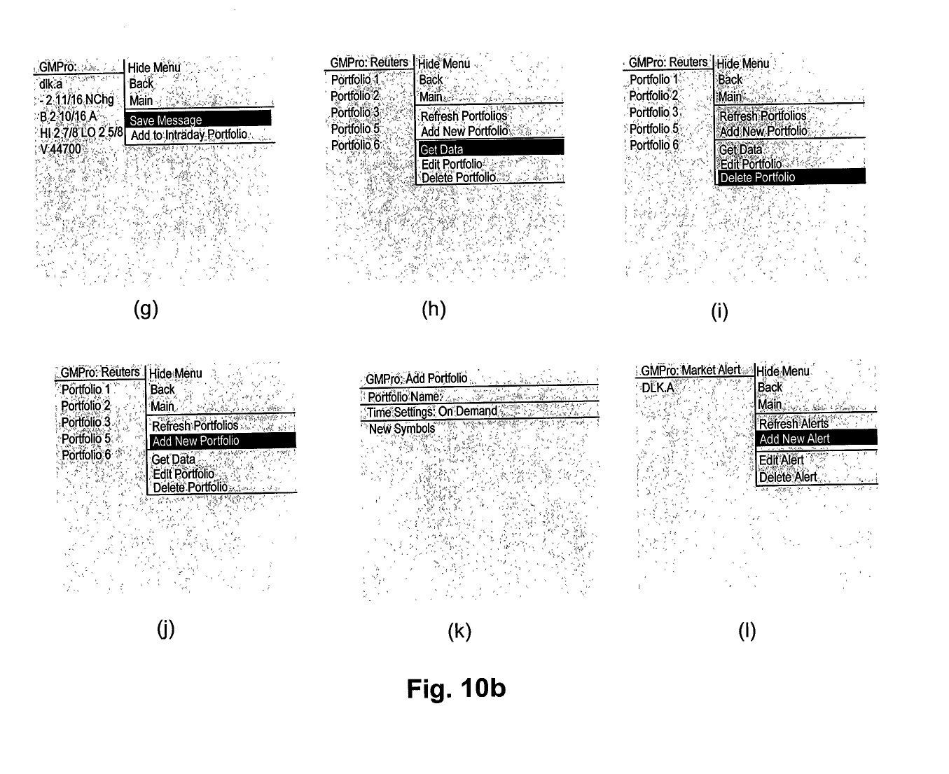

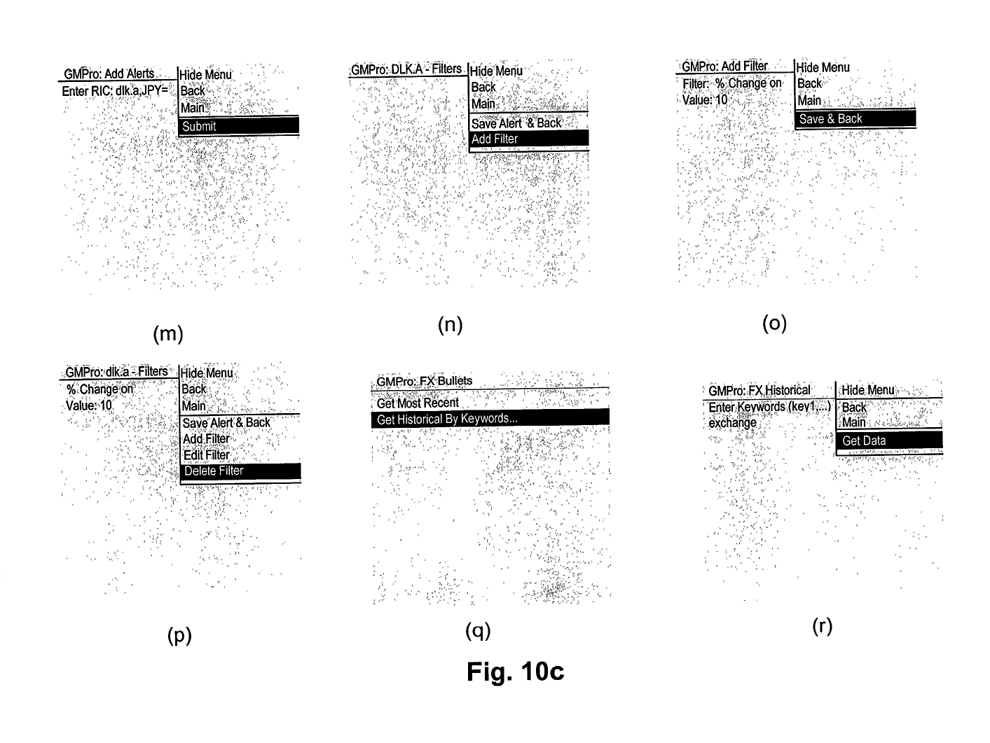

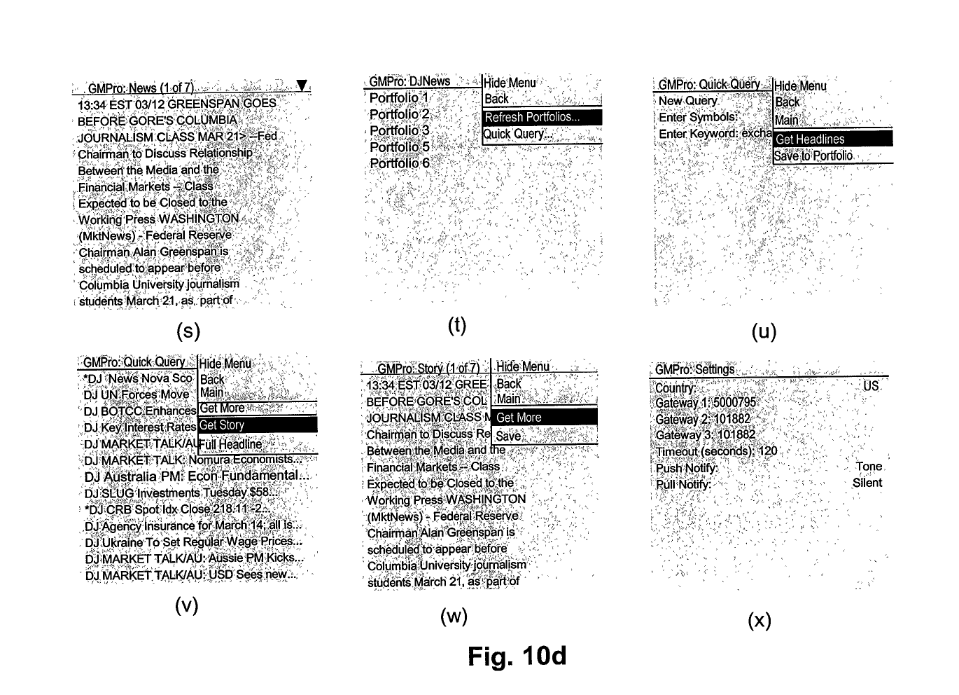

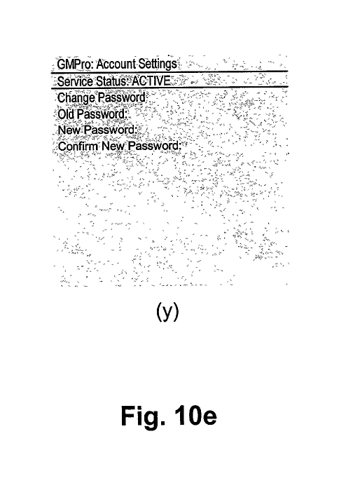

FIGS. 10a through 10d illustrate screens developed for the RIM 957™ device, arranged in screen-flow order; that is, in the order that screens will be presented in response to user's actions in prior screens.

FIG. 10a illustrates seven screens (a) through (g). Screen (a) is a top-level screen for the device, presenting selectable icons for invoking a range of services. One of these icons “GMP” is a hyperlink to Global Market Pro, and initiates contact with the GMP service via whatever communication protocol and gateway is current. Screen (b) shows the top level screen presented first by GMPro, giving the user three selectable icons, one of which (highlighted) initiates log-on. Screen (c) is the next screen presented, wherein the user may enter the account number and password, and then select to send the Login.

Assuming the login is correct and the user is authenticated, screen (d) is displayed as the GMPro main menu, providing several selections for services from GMPro. The highlighted selection in screen (d) is for Reuters Services. Screen (e) is now displayed, providing three separate services. “Get RICs” is highlighted, and when selected provides screen (f), which allows the user to enter RICs. Finally screen (g) displays the current information for RIC: dlk.a, and provides a menu whereby the user may select to hide the menu, go back, return to the main menu, save the current message, or add the displayed info to the Intraday portfolio.

If, in screen (e) of FIG. 10a the user selects Intraday Portfolios, screen (h) of FIG. 10b is provided rather than screen (f). In screen (h) the user may select a portfolio, and get data, add a new portfolio, edit the selected portfolio, or delete the selected portfolio. If “Get Data” is selected the relevant data is displayed. If “Delete Portfolio” is selected (screen (i)) the portfolio is deleted. If “Add New Portfolio” is selected (screen (j)), screen (k) is provided to accept entry for the portfolio to be added.

Returning now to screen (e) of FIG. 10a, if one selects “Market Alerts”, screen (l) of FIG. 10b is displayed, allowing the user to refresh alerts, add new alerts, edit existing alerts, or delete alerts. In response to “Add New Alert” in screen (l), screen (m) is provided, allowing the user to enter a RIC and submit.

A selection of “Edit Alert” in screen (l) enables screen (m) wherein a user may edit alerts by adding and deleting filters, using also screens (m), (n), (o) and (p) as appropriate.

Returning now to FIG. 10a, if the user selects the Dow Jones™ icon in screen (d), the system provides screen (q), which, through selection of “Get Data”, provides navigation to screen (r), where the user may select the mode for news access, and screen (s) which is a partial list of the news items matching the criteria for the user.

FIG. 10d illustrates several more screens used with the RIM 957™ device. Screen (t) lists news portfolios and allows for a quick query, which goes to screens (u), allowing entry of a keyword; then screen (v) provides the Quick Query results. One may highlight a listing and select “Get Story”, which goes to screen (w). Typically stories are longer than may be displayed in a single screen, so one may select “Get More” sequentially until the full story is provided.

Screens (x) and (y) are maintenance screens which enable a user to edit settings for the device and communication parameters (screen (x). Screen (y) allows a user to change the password.

It will be apparent to the skilled artisan that the examples provided as FIGS. 10a through 10d are exemplary only of a very wide variety of screens developed for many different sorts of communication devices.

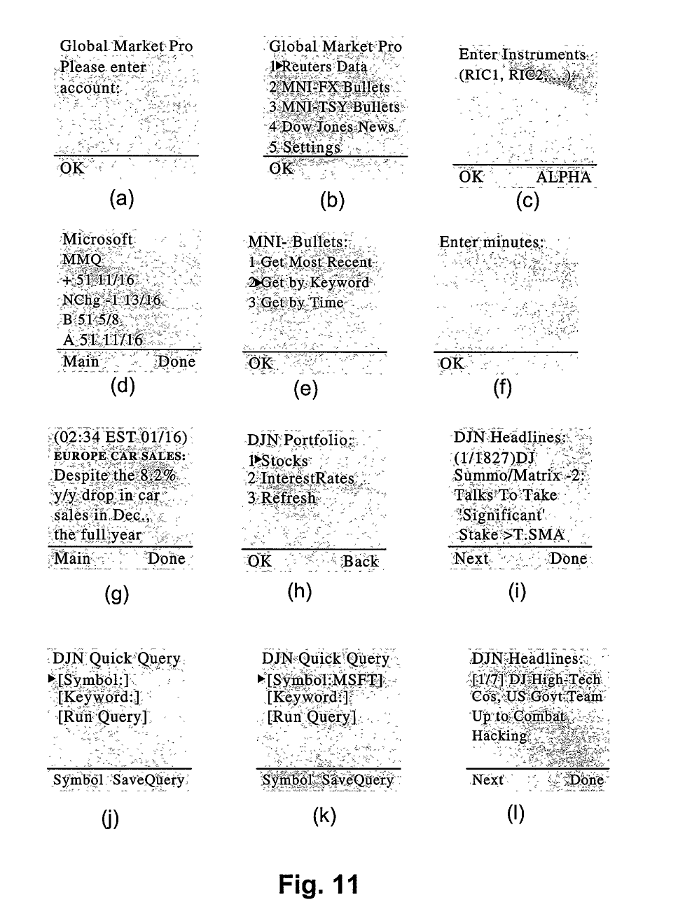

FIG. 11 illustrates twelve screens developed for communication with a WAP-enabled telephone. Top screen (a) displayed in response to the user dialing the correct number is a login screen allowing the user to enter an account and send by selecting OK. Screen (b) then presents the service options from GMPro. Selection 1 in Screen (b) provides screen (c) where a user may enter instruments by RIC, and select OK. Screen (d) is an example of an information display after a RIC is selected.

Selecting 2 in screen (b) brings screen (e) for MNI bullets. One may select by keyword, by time, or Get Most Recent. Screen (f) allows entry of a time. Screen (g) is an example of MNI bullet info display for the WAP-enabled telephone.

Selecting 4 in screen (b) brings screen (h) for Dow Jones News, and selections for Stocks, or Interest Rates. Selecting Stocks in screen (h) brings screen (i) with DJN headlines about stocks. Screen (j) allows a Quick Query by either Symbol or Keyword, and screen (k) illustrates a symbol entered. Screen (l) shows DJN headlines as a result of a Quick Query.

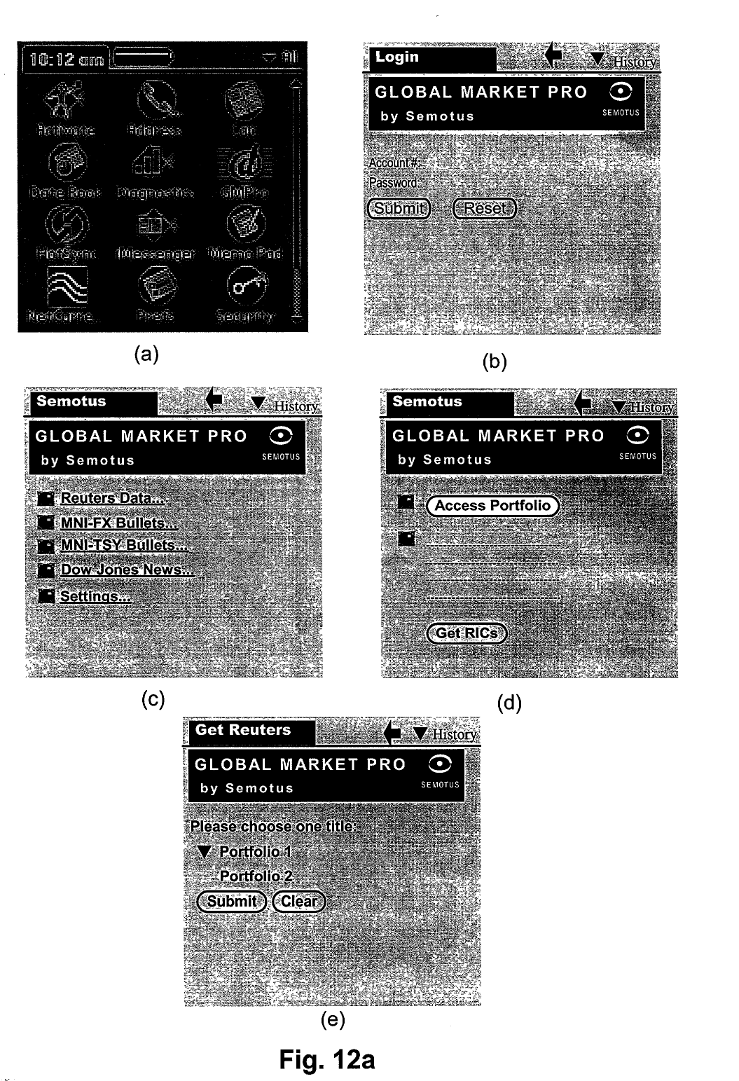

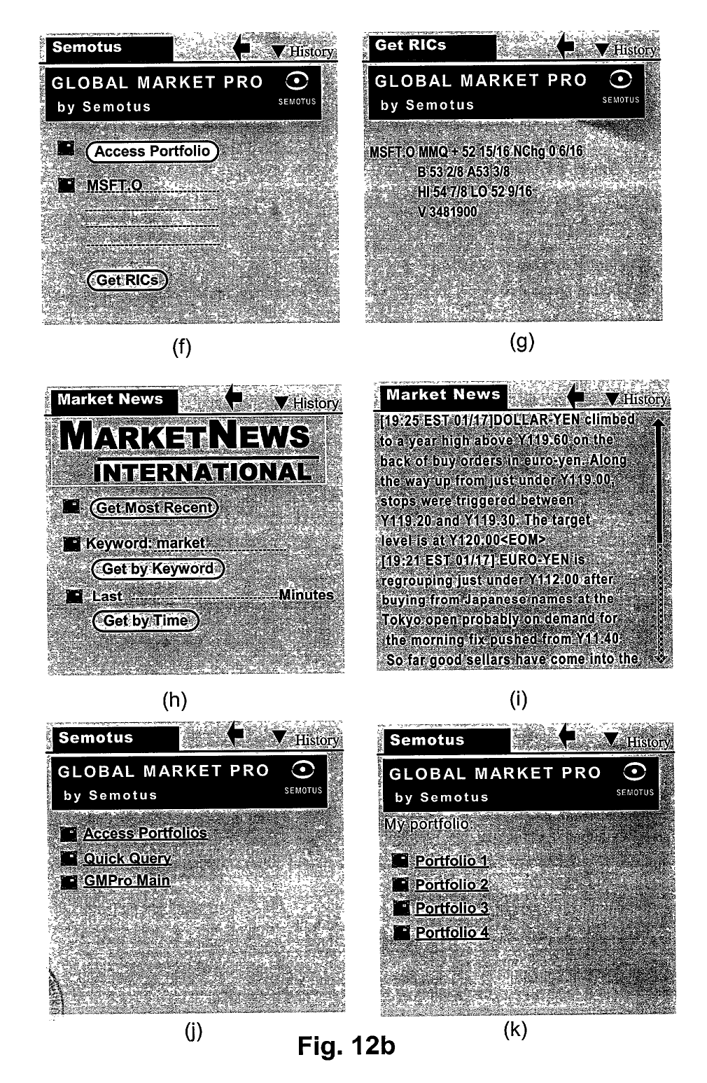

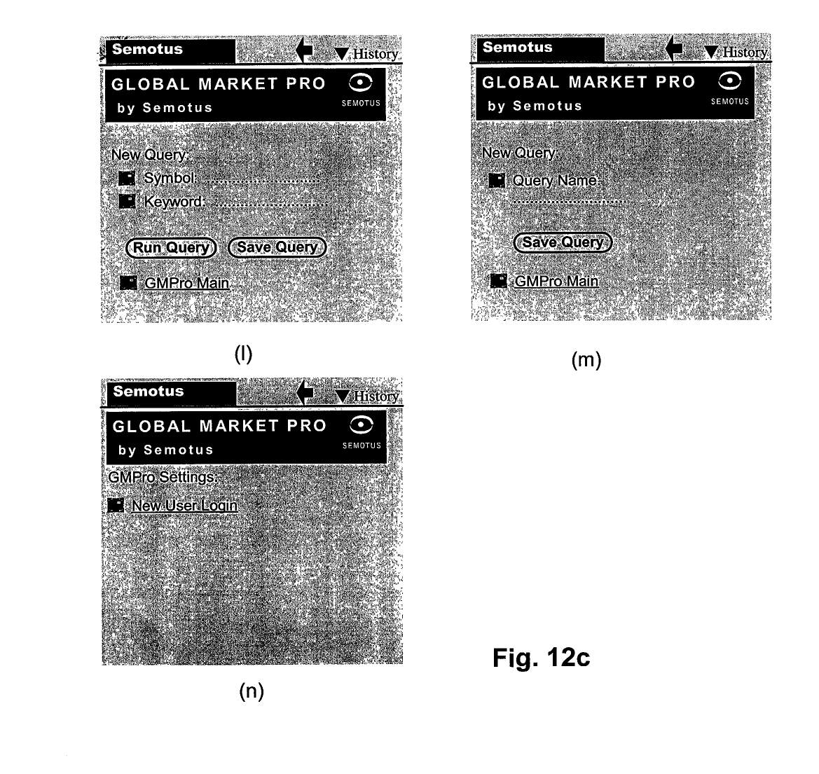

FIGS. 12a, 12b, and 12c illustrate a series of screens developed for a PalmVII™ device, which is a sophisticated and powerful device. Screen (a) of FIG. 12a is a top-level screen on the device showing an icon for GMPro. Selecting the GMPro icon brings screen (b) for login, allowing the user to enter account number and password, and to submit same for verification.

Successful login brings screen (c) of FIG. 12a, with a menu of selectable items for the GMPro system. The menu is essentially the same as the selectable functions that have been described for other devices thus far. Selecting Reuters Data from screen (c) takes the user to screen (d), where he/she may select to access a portfolio or enter a different action, or select to get RICs.

Selecting Access Portfolio in screen (d) delivers screen (e), which lists available portfolios for the specific user, and has a Submit button. Screen (f) in FIG. 12b illustrates entry of a RIC in screen (d), after which the user would use the get RICs button to go to screen (g), which in this example displays the data result for MSFT.O.

Screen (h) in FIG. 12b is a result of selecting Dow Jones News in screen (c) of FIG. 12a. Three selections are enabled, one for Get Most Recent, one for Get by Keyword, and one for Get by Time. Depending on the selection one may enter a keyword or a time span. Screen (i) shows an information display result for getting headline news from DJN.

Screen (j) illustrates a selection of Access Portfolios or Quick Query. Access Portfolios brings screen (k) listing portfolios available for access. Screen (l) in FIG. 12c is for a Query, and allows entry of a Symbol or a Keyword, and has buttons for Run Query and Save Query. Save Query brings screen (m) where the user may give the new query a name and then Save. Screen (n) is a result of selecting “settings” in screen (c) of FIG. 12a, and allows the user to enter a new login.

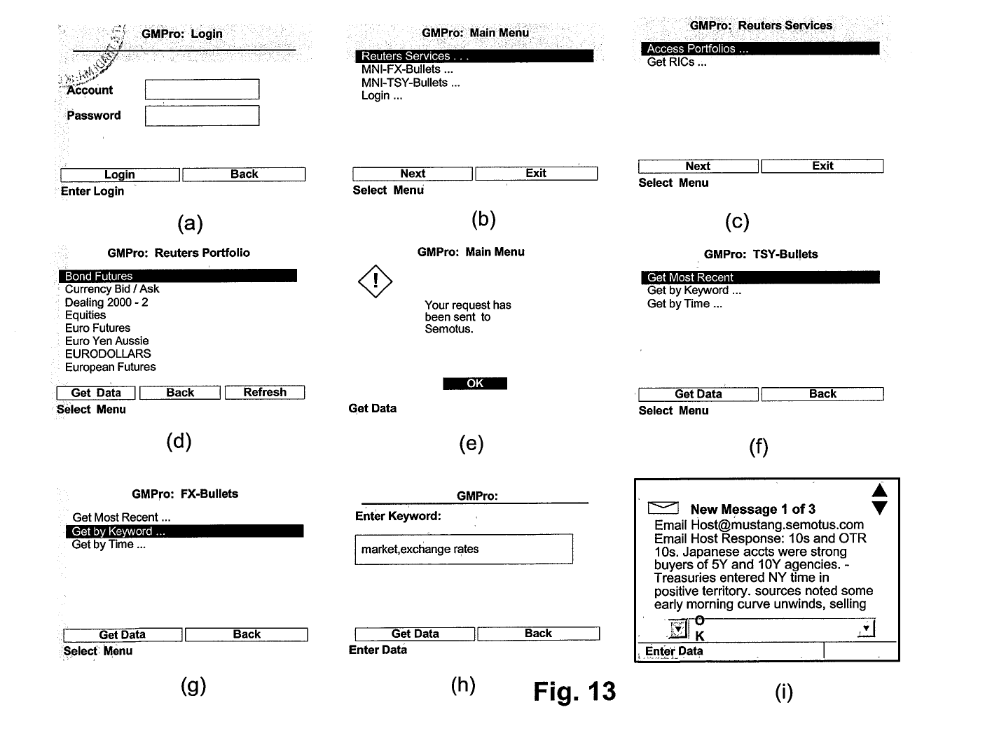

FIG. 13 illustrates a series of screens developed for a Motorola Pagewriter 2000™ device. The functionality is much the same as described previously for other devices. Screen (a) is for login, screen (b) allows function selection, screen (c) provides selection between accessing portfolios or getting RICs. Screen (d) lists a users portfolios, screen (e) is an info screen, screen (f) provides selections for TSY-Bullets, screen (g) for FX-bullets. Screen (h) allows a keyword entry for news, and screen (j) is an example of a message.

It will be apparent to one with skill in the art that the present invention may be practiced successfully using the Internet or other WAN as a base for the service along with cooperation from various wireless service providers and carriers without departing from the spirit and scope of the present invention. The entire system of the present invention provides an automated mechanism for intercepting and redirecting real-time financial data and alerts as ordered by subscribing users in a fashion as to emulate real-time market activities. For example, the response time for on-demand information ordered by users through the various wireless devices described in the specification is much less than 60 seconds. Therefore, users practicing the present invention are enabled to formulate quick decisions such as buying and selling stocks and performing other portfolio-related activities based on information received through a single interface. Users operating bi-directional communication devices with Internet capability to quickly access various service providers, such as stockbrokers and the like in order to implement decisions based on received data rendered to them by the service of present invention. Similarly, users operating omni or bi-directional communications devices not having Internet capability may simultaneously operate an Internet capable device including a personal computer for the purpose of implementing financial decisions based on the data received through the non-Internet capable devices.

The response time of the service as a whole is enabled by the fact that all internal data processing is achieved using XML or other markup language formats. It will be recognized by the skilled artisan then, that the system is scalable in terms of adding new external data sources and in terms of adding new device parameters and platforms. It will also be realized by those skilled in the art, that the service and system of the present invention may be implemented in association with a single large financial institution and made available to customers of that institution. Likewise, the service and system of the present invention may be implemented in association with any number of financial institutions in scalable fashion, as well as directly with individuals whom are using the service.

The method and apparatus of the present invention should be afforded the broadest possible scope under examination. The spirit and scope of the present invention is limited only by the claims that follow.

What is claimed is:

1. A network-based system for intercepting real-time data feeds from external data sources, stripping the intercepted feeds of user-ordered data and redirecting the stripped data to the requesting users over cooperating interfacing networks comprising:
one or more server nodes connected to the network, at least one of which is input ported for receiving data feeds from the external data sources and output ported for rendering data stripped from the feeds to requesting users;
one or more instances of software distributed to the one or more server nodes, the software for parsing data from the feeds received from the external data sources, converting the data to a common markup language for internal processing, and for converting user-ordered data results expressed in the common markup language to appropriate interface formats for the requesting users, the software also for accepting data about users and configuration data from users interfacing with the software by way of an Internet-capable appliance and supported platform; and
a mass data storage repository accessible to the one or more server nodes, the data repository for storing data stripped from feeds provided by the external data sources and for storing user profile and account data, characterized in that users subscribing to a service enabled by the system may order and receive data stripped from the data feeds provided by the external data sources in a usable presentation format personalized to each user and rendered to each user through a particular cooperating interface network to the particular wireless communication device operated by individual ones of the users, the device configured for receiving the data.

2. The network-based system of claim 1, wherein the network is the Internet network.

3. The network-based system of claim 2, wherein the cooperating interfacing networks include one or a combination of a paging network, a wireless network, and a wireless Internet service network.

4. The network-based system of claim 3, wherein the data feeds contained publicly oriented financial activity and news information.

5. The network-based system of claim 4, wherein the common markup language is eXtensible Markup Language.

6. The network-based system of claim 5, wherein the wireless communication devices configured for receiving the data rendered by the system are one of a one-way pager, a two-way pager, a hand-held computing device, or a Web enabled telephone.

7. The network-based system of claim 6, wherein the data received from external data sources is parsed and converted into eXtensible Markup Language before being converted to the appropriate data format before being rendered.

8. The network-based system of claim 7, wherein data rendered to users is of the form of alerts triggered through detection of specific and variable conditions associated with the data, the conditions configured into orders received from users.

9. The network-based system of claim 8, wherein data rendered to users further includes most recent real-time values associated with the requested data.

10. In a network-based system for intercepting real-time data feeds from external data sources, stripping the intercepted feeds of user ordered data and redirecting the stripped data to the requesting users over cooperating interfacing networks, the system having one or more server nodes connected to the network, at least one of which is input ported for receiving data feeds from external data sources and output ported for rendering data stripped from the feeds to requesting users, a software application for managing the functions of the system is provided comprising:
a user-interface component for interfacing with users the purpose of accepting data about users and for accepting orders from users;
a source-interface component for receiving data feeds from external data sources, parsing data feeds for data pertinent to user orders, and for directing the parsed data into a data repository;
a data-conversion component for equating data expressed in formats used by external sources to a common markup language for internal processing and for equating data results expressed in the common markup language to appropriate data formats used by receiving devices operated by requesting users;
a data-transport component for transporting processed data to requesting users for the output of the system; and
a database management component for managing database operations including associating appropriate data parsed through order to appropriate requesting users, characterized in a users interacting with the interface component of the software application may subscribe to the service enabled by the software, create a personal portfolio, and configure data alert and data presentation orders through the interface component for subsequent execution, processing, and rendering performed by the remaining components of the software application.

11. The software application of claim 10, wherein the user-interface component is accessible through the Internet using an Internet-capable computing device, or via wireless data networks connected to the Internet.

12. The software application of claim 11, wherein the Internet-capable computing device is a personal computer.

13. The software application of claim 11, wherein the Internet-capable computing device is a hand-held computer.

14. The software application of claim 11, distributed to a single server node in the case of one server node.

15. The software application of claim 11, distributed to more than one server node in the case of more server nodes.

16. The software application of claim 12, wherein data about users includes account data, contact data, device data, and portfolio data.

17. The software application of claim 16, wherein orders from users include conditional alert orders, time-sensitive alert orders, and event-driven alert orders.

18. The software application of claim 17, wherein the source-interface component cooperates with the data-conversion component to affect data conversion before directing the parsed data into the data repository.

19. The software application of claim 18, wherein the user-interface component cooperates with the data-conversion component to affect data conversion to data about users before storing the data and to order data before storing and initiating execution of the data orders.

20. The software application of claim 19, wherein the data-conversion component converts data results from the common markup language to the appropriate data formats before initiating the data-transport component for delivering the data.

21. The software application of claim 20, wherein orders from users received through the user-interface component result in periodic data pushes to the device of the requesting user.

22. Software application of claim 21, wherein orders are received through bi-directional interface with the data-transport component, the orders comprising on-demand orders.

23. A method for receiving real-time data feeds from data sources accessible through data connection, parsing and stripping the feeds for data portions for redirection to requesting users connected by data link comprising steps of:
(a) receiving an order for data from a user, the user sending the order through the data link;
(b) parsing a data feed identified in the received order, the data feed continually tapped by the service and the parsing performed to identify data in the feed that is requested by the order;
(c) stripping the portions of data from the data feed according to instructions contained in the order;
(d) associating the stripped portions of a data to the author of the order for the data; and
(e) transporting the requested data to the user back over the data link.

24. The method of claim 23, wherein the data connection to the external sources comprises the Internet network and the data link comprises a wireless data link facilitated by a wireless service carrier.

25. The method of claim 24 wherein in step (a), the data link is one of a wireless data link, a pager network data link, or a wireless Internet data link.

26. The method of claim 24 wherein in step (a), the order is an on-demand order initiated through one of a one-way pager, a two-way pager, a handheld computing device, or the Web enabled wireless telephone.

27. The method of claim 26 wherein in step (b), the data feed contains market activity information and the order requests the most current activity values associated with specific instruments reported by the feed.

28. A method of claim 27 wherein in step (b), the data feed contains market news information and the order requests the most current news summaries as reported by the feed.

29. The method of claim 26, wherein in step (c), instructions contained in the order pertain to one or more instruments generic to the data feed.

30. The method of claim 26, wherein steps (a)-(e) are repeated a plurality of times during one session on behalf of one user engaging in the session.

31. A method for generating and transmitting user alerts associated with current states and conditions of data contained in real-time data feeds intercepted on behalf of users by a network-based data interception and redirection service comprising steps of:
(a) receiving at the service a configuration order sent by a user the order identifying specific alert criteria and received by the service over a data link connecting the service to the user;
(b) monitoring one or more real-time data feeds identified in the configuration order received at step (a), the monitoring performed to identify the data in the feed which is identified in the configuration order and also the current state and condition of the identified data;
(c) comparing the alert criteria specified in the configuration order to the identified state and condition of the associated data; and
(d) upon determining that the current state and condition of the associated data meets the alert criteria specified in the configuration order, generating and transmitting an associated alert or alerts to the author of the configuration order.

32. The method of claim 31, wherein the network-based data interception and redirection service is implemented on Internet network.

33. The method of claim 32, wherein the data interception and redirection service utilizes interfacing wireless networks to transmit alerts to wireless devices using a push technology.

34. The method of claim 33 wherein in step (a), the data link connecting the service to the user is an Internet link and the device used to initiate the configuration order is a personal computer.

35. The method of claim 34 wherein in step (b), the real-time data feeds report traded financial instruments and current market states and conditions of those instruments.

36. The method of claim 35 wherein in step (b), monitoring of the feeds occurs periodically has specified by the configuration order.

37. The method of claim 36 wherein in step (c), comparison of alert criteria to state and condition of associated data is performed at each periodic interval of monitoring.

38. The method of claim 37 wherein in step (d), transmission of a generated alert or alerts is conducted through an interfacing wireless network to a configured wireless device adapted to receive the alert or alerts.

39. The method of claim 38 wherein in step (d), the wireless device is a one-way paging device and interfacing network is a pager network.

40. The method of claim 38 wherein in step (d), the wireless device is a two-way paging device.

41. The method of claim 38 wherein in step (d), the wireless device is a Web enabled telephone and interfacing network is a wireless network.

42. The method of claim 38 wherein in step (d), a wireless device is a handheld computing device and interfacing network is a wireless Internet network.
